(19) United States
(12) Patent Application Publication
(10) Pub. No.: US 2004/0136801 A1
(43) Pub. Date: Jul. 15, 2004

(54) Screw nut for limiting an acting torque and method corresponding thereto

(76) Inventors: Joachim Schneider, Ehringshausen (DE); Frank Drexler, Ortenberg (DE)

Correspondence Address: HARNESS, DICKEY & PIERCE, P.L.C., P.O. BOX 828, BLOOMFIELD HILLS, MI, 48303, US

(21) Appl. No.: 10/704,045

(22) Filed: Nov. 7, 2003

Related U.S. Application Data
(63) Continuation of application No. PCT/EP02/04018, filed on Apr. 11, 2002.

(30) Foreign Application Priority Data
Apr. 23, 2001 (DE) 101 19 913.9

(51) Int. Cl. F16B 31/00

(52) U.S. Cl. 411/3

(57) ABSTRACT

The present invention relates to a screw nut (10) for limiting an acting torque and a method corresponding thereto. The screw nut (10) has a threaded section (1) and a tubular section (2), where a predetermined breaking point (3) is arranged between the threaded section (1) and the tubular section (2), and where the threaded section (1) has a first shoulder structure (6) for a wrench and the tubular section (2) has a second shoulder structure (7) for an additional wrench.

The screw nut (10) according to the invention preferably consists of a synthetic material, in particular of a polymer such as polyamide. This has the advantage that particularly the region of the predetermined breaking point (3) may consist of a material differing from, in particular softer than, the threaded section (1) and/or the tubular section (2), and therefore a defined torque limitation is obtainable not only via the geometry of the predetermined breaking point (3) but also or exclusively via selectively processed material of suitable quality.

### BACKGROUND AND SUMMARY OF THE INVENTION

The present invention relates to a screw nut for limiting an acting torque and a method corresponding thereto.

Screw nuts as such are well known. In the main, they are assembled manually or in automated fashion by a torque wrench, which mechanically limits the acting torque. However, the torque actually acted on frequently cannot be seen in an assembled screw nut.

FR 7,728,290, for example, also discloses a screw nut that has a geometrically designed predetermined breaking point. However, such a nut can only function properly when the screw-on moment is transmitted from the wrench surface via the predetermined breaking point to the thread in the lower region. In the case of the nut proposed in FR 7,728,290, however, it remains unclear how, for example, a defined stripping is to take place, when in the case of strong friction in the upper part of the internal thread, for instance in a stud projecting into the tubular section, the predetermined breaking point does not even come to bear, because the introduction of force takes place not only via this joint but also via the stud end.

The screw nut disclosed in GB 2,153,948 appears to solve this problem. However, it has the disadvantage in particular that it can be removed only with difficulty or not at all, and with damage to an adjacent structural part.

The object of the present invention is to indicate a screw nut, improved with respect to the known prior art, for limiting an acting torque, as well as a method corresponding thereto. According to the invention, this object is accomplished by a screw nut having the features according to Claim 1 and by a method for limiting an acting torque having the features of Claim 15. Advantageous refinements and embodiments, which may be applied individually or in combination with one another, are the subject of the respective subclaims.

The screw nut according to the invention for limiting an acting torque has a threaded section and a tubular section, where a predetermined breaking point is arranged between the threaded section and the tubular section, and where the threaded section has a first shoulder structure for a wrench and the tubular section has a second shoulder structure for an additional wrench. In the simplest case, an open-end wrench or comparable outside tool may be considered to be a suitable tool. Such a screw nut advantageously avoids the disadvantages mentioned at the beginning. Thus, on the one hand, a defined torque actually delivered is visible on the assembled screw nut by the stripped tubular section; the latter, because of the absent force-fitting or frictional connection, advantageously ensures the exclusive transmission of force via the predetermined breaking point to the threaded section, whose first shoulder structure advantageously permits simple disassembly at any time.

According to the invention, the predetermined breaking point preferably has an outside diameter that is smaller than the outside diameter of the threaded section as well as smaller than the outside diameter of the tubular section. The precise dimension of such a clearance or constriction or joint permits the defined transmission of a given maximum torque. If the geometric dimension for a screw nut of a given range of application is varied each time, production of any desired screw nuts having a predefined torque limitation in each instance advantageously is possible by simple means.

The problem mentioned at the beginning, namely that in the event of strong friction in the upper part of the internal thread, for instance in the case of a stud projecting into the tubular section, the predetermined breaking point does not even come to bear because the introduction of force takes place not only via this joint but also via the stud end, is in addition reduced in that, when the tubular section preferably is designed funnel-shaped in such a way that, starting from an outside or nominal diameter of an internal thread of the threaded section, it widens in direction away from the latter; i.e., the said stud end is reliably released, so that the introduction of force preferably takes place exclusively via the predetermined breaking point.

Alternatively or cumulatively, the tubular section may also be designed cylindrical, where it preferably has a greater diameter than the outside or nominal diameter of the internal thread of the threaded section. Both measures help to further or completely reduce the friction between screw nut and a stud that may perhaps be too long, so that nothing stands in the way of the desired fracture of the screw nut in the region of the predetermined breaking point at a defined applied torque. For example, for simplifying production of a mold for the screw nut, it is proposed that the tubular section likewise have an internal thread, the outside or nominal diameter of the internal thread of the tubular section being greater than the outside or nominal diameter of the internal thread of the threaded section.

If the assembly space of the screw nut for an outside tool such as an open-end wrench is limited, use preferably is made of inside tools such as a hexagonal socket wrench or comparable tool. It is therefore proposed that in the tubular section a third shoulder structure be designed for an inside tool, for example a structure for the said hexagonal socket or comparable tool. The first and the second shoulder structures preferably have approximately like dimensions when only the design of as simple and inexpensive as possible a production tool for the screw nut is involved.

However, if defined, where possible even guaranteed, torques are the focus of application of such screw nuts, it is proposed that the first and the second shoulder structures have unlike, i.e., greater or smaller, dimensions, in particular describe unlike, preferably not measurable or comparable, i.e., incommensurable, polygons. This advantageously already permits quality control during assembly, since a mechanic, in case of necessary disassembly of an incorrectly tightened screw nut, is not able to subsequently tighten such a screw nut correctly simply by means of the existing tool via the first shoulder structure and hence only visually. Rather, he is forced to provide himself with a suitable repair tool, such an operating routine advantageously making it possible to ensure that the incorrectly tightened screw nut is also actually disassembled and in its stead a new screw nut is assembled in the specified torque region.

The screw nut may be made of metal. However, according to the invention, it is a part of synthetic material that preferably consists of a polymer such as polyamide. For achieving desired torque limitations, in particular including in the case of small screw nuts, it is proposed that the predetermined breaking point consist of a material differing from, in particular softer than, the threaded section and/or the tubular section. This has the advantage that the desired torque limitation is obtainable not only via geometry but also or exclusively via material properties. In this case, the threaded section, the tubular section and/or the predetermined breaking point preferably are molded onto one another by the two-component injection molding technique.

According to the invention, the internal thread of the threaded section preferably is designed as a Christmas-tree thread. Such a Christmas-tree thread is in addition then preferably also formed at least partially in the region of the tubular section when, on the one hand, screw nuts with as low as possible a total height, alternatively or cumulatively are to be made with at least three, preferably at least four, in particular at least five flights of thread, which advantageously withstand desired torque values as well as removal values. Although with stripping of the tubular section the end of the internal thread is also invariably deformed, possible disassembly of such a screw nut having a Christmas-tree thread is obtainable by simple twisting off because a Christmas-tree thread advantageously is self-cutting.

The method according to the invention for limiting a torque acting on the screw nut according to the invention is characterized in that an outside tool acts on the second structure or an inside tool acts on the third structure in such a way that the tubular section, upon action of a defined torque in the region of the appropriately designed predetermined breaking point, shears off.

### BRIEF DESCRIPTION OF THE DRAWINGS

Additional details and further advantages are described below by a preferred example of a screw nut and by the drawings, wherein:

FIG. 1 shows a screw nut according to the invention having a funnel-like tubular section in the side view;

FIG. 2, a screw nut according to the invention having a cylindrical tubular section in the side view;

FIG. 3, the screw nut of FIGS. 1 or 2 in top view with a first and a second shoulder structure of like dimensions; and

FIG. 4, the screw nut of FIGS. 1 or 2 in top view with a first and a second shoulder structure of unlike dimensions.

### DETAILED DESCRIPTION

FIG. 1 shows a screw nut 10 according to the invention for limiting an acting torque, having a threaded section 1 and a funnel-shaped tubular section 2 in the side view. A predetermined breaking point 3, which is designed as a clearance or constriction, is arranged between the threaded section 1 and the tubular section 2. In other words, the predetermined breaking point 3 has an outside diameter that is smaller than the outside diameter or an outside dimension of the threaded section 1 as well as smaller than the outside diameter or an outside dimension of the tubular section 2. The latter may be designed for example funnel-shaped in such a way that, starting from an outside or nominal diameter of an internal thread 5 of the threaded section 1, it widens in direction away from the latter.

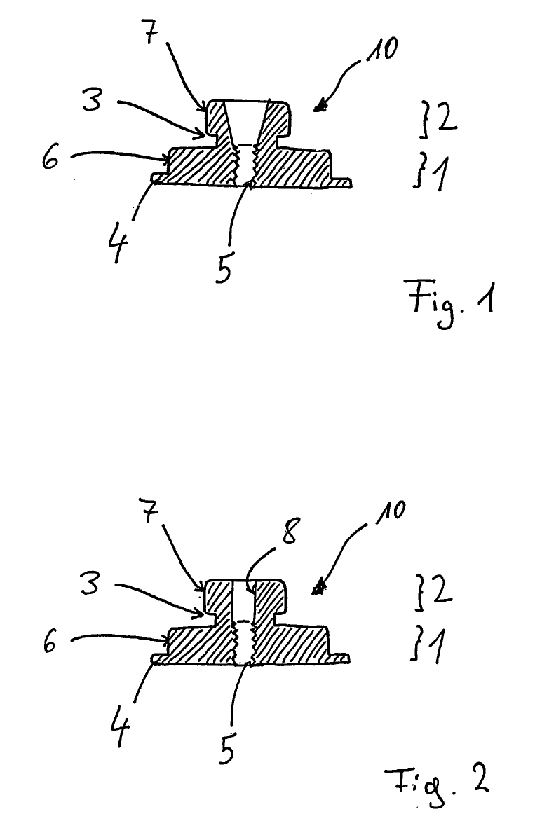

Alternatively to the funnel-shaped design of the tubular section 2 shown in FIG. 1, according to the invention the latter may alternatively preferably be designed cylindrical, as is shown in FIG. 2. Such a cylindrically designed tubular section 2 then advantageously has a greater diameter than the outside or nominal diameter of the internal thread 5 of the threaded section 1.

The two embodiments described (funnel-shaped or cylindrical) advantageously help to minimize the problem described at the beginning, that in the case of strong friction in the upper part of the internal thread 5, perhaps in a stud (not illustrated) projecting into the tubular section 2, the predetermined breaking point 3 does not come to bear at all, because the introduction of force does not take place only via this joint but also via the stud end.

As can be seen in FIG. 1 or FIG. 2, at least the tubular section 2 has a second shoulder structure 7 for a tool, in the simplest case an open-end wrench or comparable outside tool. A third shoulder structure 8 for an inside tool advantageously is designed in the tubular section 2, for example as a square or hexagon or the like. In particular, for the purpose of disassembly of an assembled screw nut 10, it has in the region of the threaded section 1 a first shoulder structure 6 for an additional tool, advantageously again an outside tool.

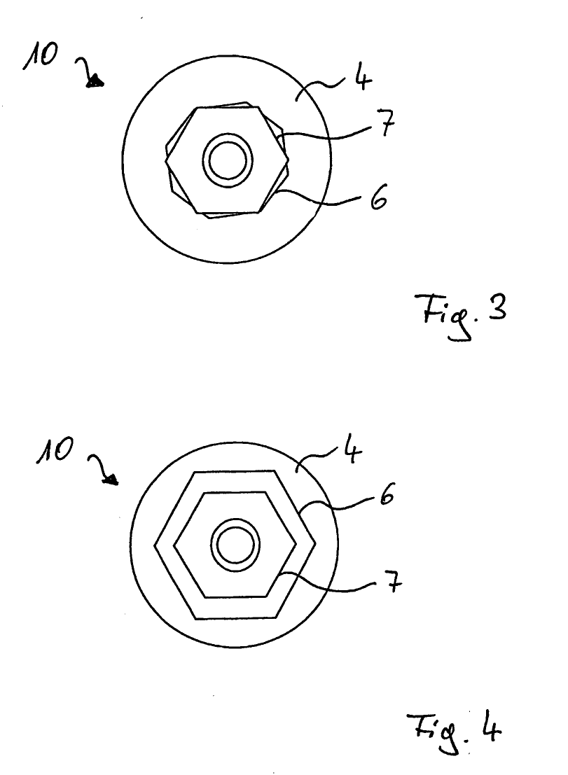

FIG. 3 shows the screw nut 10 of FIG. 1 or 2 in top view with a first 6 and a second 7 shoulder structure of like dimensions. An optionally provided flange 4 for example advantageously improves the seating or tightness of a structural part (not illustrated) in the region of the screw nut 10. In addition, such a screw nut 10 prevents a stud cooperating with it, for instance, from being torn out of a metal sheet.

According to the invention, the screw nut 10 preferably has first and second shoulder structures 6, 7 of unlike dimensions, as is illustrated in FIG. 4. Accordingly, the first shoulder structure 6 may for example have a greater dimension than the second shoulder structure 7, in particular—as shown—not comparable, i.e., incommensurable, polygons.

The screw nut 10 according to the invention preferably consists of a synthetic material, in particular of a polymer such as polyamide. This has the advantage that particularly the region of the predetermined breaking point 3 may consist of a material differing from the threaded section 1 and/or the tubular section 2, in particular a softer material, i.e., a defined torque limitation is obtainable not only via the geometry of the predetermined breaking point 3 but also or exclusively via selectively processed material of suitable quality.

The invention claimed is:

1. A nut comprising:
a first section having an outside surface with at least one tool-engagable flat, the first section having a first internal bore with a thread-like pattern thereon;
a second section having an outside surface with at least one tool-engagable flat, the second section having a second internal bore aligned with the first internal bore of the first section, the second internal bore of the second section being free of threads; and
a third section located between the first and second sections, the third section having an outside surface of a smaller lateral dimension than the lateral outside surface dimensions of the first and second sections;
the third section being breakable when a predetermined installation force is reached.

2. The nut of claim 1 wherein the lateral dimension of the outside surface of the first section is greater than that of the second section, and the installation force is rotational torque.

3. The nut of claim 1 wherein the outside surface of the first section defines a polygon and the outside surface of the second section defines a polygon.

4. The nut of claim 1 wherein the second internal bore of the second section has a substantially conical shape expanding away from the first section.

5. The nut of claim 1 wherein at least one of the sections is polymeric.

6. The nut of claim 1 wherein a material of the third section is substantially softer and more breakable than that used to make the first and second sections.

7. A nut comprising:
a first portion having an outside surface with flats, the first portion having a first passageway with a thread-like pattern thereon;
a second portion having an outside surface with flats, the second portion having a second passageway coaxial with the first passageway of the first portion, the second passageway of the second portion being free of threads; and
a third portion located between the first and second portions;
a material of the third portion being substantially softer and more breakable than that of the first and second portions.

8. The nut of claim 7 wherein a lateral dimension of the outside surface of the first portion is greater than that of the second portion.

9. The nut of claim 8 wherein a lateral dimension of an outside surface of the third portion is less than that of the first and second portions.

10. The nut of claim 7 wherein the outside surface of the first portion defines a polygon and the outside surface of the second portion defines a polygon.

11. The nut of claim 7 wherein the second passageway of the second portion has a substantially conical shape expanding away from the first portion.

12. The nut of claim 7 wherein at least one of the portions is polymeric.

13. A nut comprising:
a first section having a polygonal outside surface, the first section having a first internal bore with a thread-like pattern thereon;
a second section having a polygonal outside surface, the second section having a second internal bore coaxial with the first internal bore of the first section, the second internal bore of the second section having a conical shape outwardly expanding away from the first section; and
a third section located between the first and second sections, the third section having an outside surface of a smaller lateral dimension than the lateral outside surface dimensions of the first and second sections, the lateral dimension of the outside surface of the first section is greater than that of the second section;
the third section being breakable when a predetermined installation force is reached;
wherein at least one of the sections is polymeric.

14. The nut of claim 13 wherein the second internal bore of the second section is free of threads.

15. The nut of claim 13 where the installation force is rotational torque.

16. A method of using a nut having a first section, a second section and a third section with a first tool and a second tool, the method comprising:
(a) engaging the first tool with the first section;
(b) supply torque to the first tool engaging the first section in order to rotationally install the nut;
(c) intentionally breaking the second section during step (b);
(d) engaging the second tool with the third section, the third section having a different outside dimension than the first and second sections; and
(e) reverse torquing the second tool and engaged third section to remove the nut.

17. The method of claim 16 further comprising only threadably engaging a stud internal to the third section.

18. The method of claim 16 further comprising making the second section from a material softer and more breakable than that used to make the first and third sections.

19. The method of claim 16 further comprising making the nut from a polymeric material.

20. A method of making a nut comprising:
(a) creating multiple sections of differing peripheral sizes from a polymeric material;
(b) creating an intentionally breakable area which limits installation forces;
(c) creating an internally threaded passageway on one side of the breakable portion; and
(d) creating a substantially smooth and unthreaded passageway on the opposite side of the breakable portion from that of step (c).

21. The method of claim 20 further comprising creating a substantially conical shape in the smooth and unthreaded passageway.
